(19) United States
(12) Patent Application Publication
(10) Pub. No.: US 2025/0178662 A1
(43) Pub. Date: Jun. 5, 2025

(54) STEERING ACTUATOR

(71) Applicant: Schaeffler Technologies AG & Co. KG, Herzogenaurach (DE)

(72) Inventors: Philip Wurzberger, Aurachtal (DE); Marko Treczka, Dormitz (DE); Mario Arnold, Aurachtal (DE); Christian Doerner, Sugenheim (DE)

(73) Assignee: Schaeffler Technologies AG & Co. KG, Herzogenaurach (DE)

(21) Appl. No.: 18/842,421

(22) PCT Filed: Nov. 29, 2022
(86) PCT No.: PCT/DE2022/100891

§ 371 Date: Aug. 29, 2024

(30) Foreign Application Priority Data
Mar. 3, 2022 (DE) 10 2022 104 980.9

(51) Int. Cl. B62D 5/04

(52) U.S. Cl. CPC B62D 5/0445

(57) ABSTRACT

The invention relates to a steering actuator, in particular of a rear-axle steering system, comprising a housing and a push rod guided therein, with an anti-rotation mechanism being active between the housing and the push rod. The anti-rotation mechanism comprises two sliding elements which are disposed on opposite circumferential sides of the push rod and each contact an inner wall of the housing. The inner wall of the housing is axially parallel with the abutment faces. The sliding elements are connected to the push rod so as to be immobile in the circumferential direction and in the axial directions.

### CROSS-REFERENCE TO RELATED APPLICATIONS

This application is the U.S. National Phase of PCT Application No. PCT/DE2022/100891 filed on Nov. 29, 2022, which claims priority to DE 10 2022 104 980.9 filed on Mar. 3, 2022, the entire disclosures of which are incorporated by reference herein.

### TECHNICAL FIELD

The disclosure relates to a steering actuator suitable for use in a rear-axle steering system of a motor vehicle.

### BACKGROUND

A steering actuator of the type in question is known, for example, from DE 10 2018 130 228 B3. The known steering actuator comprises a push rod that can be displaced within a housing. An anti-rotation mechanism prevents the push rod from rotating about its own longitudinal axis. The anti-rotation mechanism of the actuator according to DE 10 218 130 228 B3 has a guide element which is guided in the axial direction in a one- or multi-part slide rail arranged on the housing. An elastomer ring is arranged between the slide rail and the housing. The elastomer ring in particular has the task of dampening structure-borne noise that occurs as a result of a reversal in the actuating direction of the actuator.

Further actuators for rear-axle steering systems of vehicles are disclosed, for example, in documents DE 10 2020 105 195 A1 and DE 10 2019 115 936 A1. In these cases too, an anti-rotation mechanism ensures that a push rod can be displaced in its longitudinal direction but cannot rotate about its own axis.

In the case of a steering actuator for a rear-axle steering system described in DE 10 2015 219 198 B4, an anti-rotation function is supposed to be achievable by polygon profiles of components that can be displaced relative to one another. To achieve the same effect, different eccentric contours are formed in the case of components of an actuator described in DE 10 2016 206 576 B3.

A steering actuator according to the features of the preamble of claim 1 is known from DE41 38 884 A1.

### SUMMARY

The disclosure is based on the object of specifying a steering actuator which is further developed with respect to the prior art and is particularly suitable for a rear-axle steering system of a vehicle, and which has an anti-rotation mechanism effective between a push rod and an actuator housing, which anti-rotation mechanism is characterized by a particularly production-friendly, robust and compact design.

According to the disclosure, this object is achieved by a steering actuator having the features described herein. The steering actuator comprises, in a basic concept known per se, a housing and a push rod guided in the housing, with an anti-rotation mechanism being effective between the housing and the push rod. The anti-rotation mechanism comprises two sliding elements arranged on opposite circumferential sides of the push rod, i.e. positioned in mirror image to each other, each contacting an inner wall of the actuator housing.

In comparison to conventional solutions in which an element of an anti-rotation mechanism protrudes from a displaceable rod in the radial direction, the steering actuator according to the application requires a comparatively small amount of space in the radial direction of the push rod due to the arrangement of the sliding elements adjacent to the push rod. Due to the arrangement of the sliding elements close to the central axis of the push rod, for a given torque acting in the push rod, larger forces tend to occur within the anti-rotation mechanism than with conventional anti-rotation mechanisms in which torque support is provided at a greater distance from the central axis of the machine part to be secured against rotation.

However, this effect, which is caused by supporting a torsional load in regions close to the axis, is at least partially compensated for or even overcompensated for by the fact that the anti-rotation mechanism provides a double support of the push rod, namely in two diametrically opposite regions. In the circumferential regions of the push rod which lie between the two sliding elements, there is no contact between the push rod and the housing. The anti-rotation mechanism of the steering actuator according to the application is therefore less demanding in terms of its manufacture than known anti-rotation mechanisms with form-fittingly interlocking polygonal, for example square, anti-rotation contours.

At the same time, the symmetrical arrangement of the two sliding elements of the steering actuator according to the application ensures that forces acting within the anti-rotation mechanism, which are attributable to a torque in the push rod, do not act in the sense of displacing the central axis of the push rod from its original position. In principle, without departing from the principle of the symmetrical arrangement of the sliding elements, a plurality of sliding elements can also be arranged one behind the other on both sides of the push rod in the longitudinal direction of the push rod.

In all cases, the push rod is intended for articulated coupling with chassis elements, in particular tie rods, which serve to adjust the steering angle of the wheels of a vehicle. In particular, this concerns the rear wheels of a motor vehicle. It is also possible to use the steering actuator in the front-axle steering system of a motor vehicle.

The two sliding elements of the anti-rotation mechanism are arranged on flattened abutment faces of the push rod, with the distance between the abutment faces being smaller than the diameter of the push rod. The diameter of the push rod is understood to be the diameter in the section of the push rod in which the sliding elements are also arranged. In a possible embodiment, the identical diameter is also present in the immediately adjacent sections in the axial direction, i.e. in the upstream and downstream sections of the push rod in the direction of displacement of the push rod.

The inner wall of the housing, which is in sliding contact with the sliding elements, is axially parallel to the flattened abutment faces of the push rod. The sliding elements can be easily manufactured as cuboid-shaped components, for example by injection molding from a suitable injection-moldable material. Opposite sides of this sliding element can be axially parallel and flat and can bear, on the one hand, against the abutment faces of the push rod and, on the other hand, against the inner wall of the housing, if necessary with some play for smooth sliding of the push rod.

Each of the sliding elements can, for example, be mounted on a pin formed as an integral part of the push rod and protruding from the abutment face.

In the case of a circular cross section of the push rod, the two pins, which have a common central axis that intersects the central axis of the push rod at right angles, do not protrude in an advantageous embodiment beyond the cylinder described by the cylindrical circumferential surface of the push rod. This provides good conditions for machining the abutment faces and the pins. This also applies to variants in which each sliding element is mounted on a plurality of pins.

Even in embodiments in which each sliding element is mounted on only one single pin, rotations of the sliding elements about the central axis of the pins can be prevented in a simple manner in that at least sections of the outer contours of the sliding elements bear form-fittingly against counter-contours of the push rod.

The at least two sliding elements of the anti-rotation mechanism each have, for example, a rectangular basic shape, wherein the extension of each sliding element in the longitudinal direction of the push rod can be greater than the extension of the sliding element in the orthogonal tangential direction of the push rod.

The sliding elements are immovably connected to the push rod in the circumferential direction and in the axial directions. For example, each of the sliding elements is screwed to the push rod. In general, frictional and/or form-fitting or integral connections and mechanisms are suitable for holding the sliding elements on the push rod. In any case, when the steering actuator is operated, relative movements occur between its housing and the sliding elements, not between the sliding elements and the push rod. For example, retaining elements integrated into the steering linkage can be provided to hold the sliding elements. The sliding elements can be arranged fixed to the shaft.

In various types of mounting of the sliding elements, these can be mounted resiliently on the push rod, wherein the spring loading of the sliding elements allows their distance from the central axis of the push rod to be at least minimally variable. The resilient effect can be achieved, for example, by inserting non-metallic elements between the sliding element and the push rod. O-rings or profile seals, for example, can be used as resilient elements, especially those made of an elastomer. Any minimal deflection of the push rod about its own axis, which is due to the flexible mounting of the sliding elements, is irrelevant with respect to the function of the anti-rotation mechanism.

Polymer sliding materials are particularly suitable as materials for producing the sliding elements. Reference is made in this context, for example, to documents DE 10 2017 210 783 A1 and DE 39 13 893 A1.

Sliding composite materials can also be considered for manufacturing the sliding elements. Sliding bearing parts made of composite materials are known in principle, for example, from documents DE 10 2015 202 561 A1 and DE 10 2017 103 940 B4.

The housing of the steering actuator is made in particular of a light metal alloy, in particular of an aluminum alloy. Within the anti-rotation mechanism, there can be direct contact between the sliding elements and the light metal from which the housing is made.

The steering actuator can be used, among other things, in an electromechanically operated rear-axle steering system of a motor vehicle, in particular a passenger car. The push rod is adjusted via a transmission, which converts a rotation into a linear movement, i.e. into the displacement of the push rod. Such a transmission, i.e. rotation-translation transmission, can be designed in particular as a ball screw drive or as a planetary rolling contact gear unit. Rear-axle steering systems with a spindle drive, which is designed as a ball screw drive or as a planetary rolling contact gear unit, are known in principle, for example, from DE 10 2020 106 785 A1.

The input-side rotating element of the rotation-translation transmission can, for example, be driven electrically directly or via another transmission, typically a rotation-rotation transmission, for example in the form of a continuously variable transmission, in particular a belt drive.

### BRIEF DESCRIPTION OF THE DRAWINGS

Several exemplary embodiments of the disclosure are explained in more detail below by means of drawings. In the drawings:

FIG. 1 shows a steering actuator comprising an anti-rotation mechanism for a rear-axle steering system in a sectional view;

FIG. 2 shows components of the steering actuator according to FIG. 1 in a perspective representation;

FIG. 3 shows a plan view of components of the steering actuator according to FIG. 1;

FIG. 4 shows a section of a push rod of the steering actuator according to FIG. 1;

FIG. 5 shows details of an anti-rotation mechanism of a steering actuator modified with respect to FIG. 1; and

FIG. 6 shows a schematic representation of a rear-axle steering system including a steering actuator.

### DETAILED DESCRIPTION

Unless otherwise stated, the following explanations relate to all the exemplary embodiments. Parts that correspond to each other or have basically the same effect are denoted with the same reference signs in all the figures.

A steering actuator 1 is intended for use in a rear-axle steering system 20 of a motor vehicle, not shown in detail. In a housing 2 of the steering actuator 1, a push rod 3 is guided so as to be displaceable but not rotatable, wherein an anti-rotation mechanism 4 provided for this purpose comprises two sliding elements 5, 6, which are located laterally on abutment faces 7, 8 of the push rod 3 and which each contact an inner wall 10 of the housing 2.

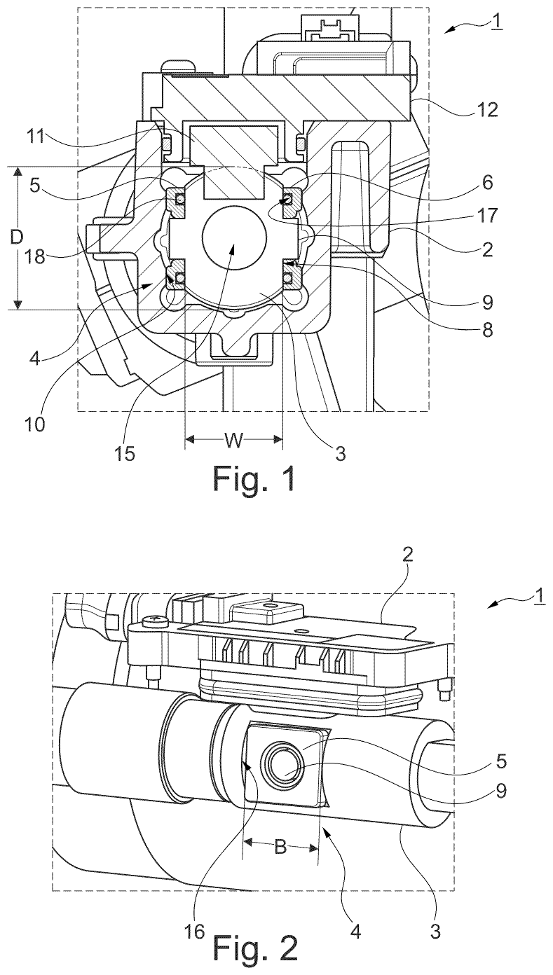

The two sliding elements 5, 6 are arranged in mirror image to a mirror plane intersecting the central axis of the push rod 3 and each have a width B to be measured in the longitudinal direction of the push rod 3 and a height H orthogonal thereto to be measured in the tangential direction of the push rod 3. Each sliding element 5, 6 has the basic shape of a rectangular plate with a central opening. In the case of FIGS. 1 to 4, the sliding elements 5, 6 are each fitted with their central opening onto a pin 9 which protrudes from the abutment face 7, 8 as an integral part of the push rod 3. In the case of FIG. 5, the sliding elements 5, 6 are each held on the push rod 3 with a screw 19.

In both cases, the mounting of the sliding elements 5, 6 is designed such that they still have at least slight mobility in the radial direction of the push rod 3. The play-free contact of the sliding elements 5, 6 on the inner wall 10 is achieved by O-rings 18, which act as resilient elements between the push rod 3 and the sliding elements 5, 6. The O-rings 18 are inserted into grooves 17 of the sliding elements 5, 6.

The abutment faces 7, 8 are offset inwards, i.e. towards the central axis of the push rod 3, relative to the otherwise cylindrical circumferential surface of the push rod 3, which has a circular cross section, such that abutment edges 16 are formed at each of the two lateral edges of the abutment faces 7, 8, which abutment edges prevent rotation of the sliding element 5, 6 about the pin 9 or about the central axis of the screw 19. The distance between the two abutment faces 7, 8 is denoted by W and is smaller than the diameter of the push rod 3 denoted by D in the corresponding region.

The inner wall 10 of the housing 2, which is in sliding contact with the sliding elements 5, 6, is axially parallel to the flattened abutment faces 7, 8 of the push rod 3. The sliding elements 5, 6 are cuboid-shaped. Opposite sides of both sliding elements are—outside the region of the connection to the push rod 3—axially parallel and flat and bear, on the one hand, against the abutment faces 7, 8 of the push rod 3 and, on the other hand, against the axially parallel inner wall 10 of the housing 2, if necessary with some play for smooth sliding of the push rod 3.

It can be clearly seen from FIG. 1 that the inner walls 10 of the housing 2, which are opposite one another on both longitudinal sides of the push rod 3, extend far enough in relation to the axis of the push rod 3 that the sliding elements 5, 6 rest flat. The extension of the sliding contact in the planes parallel to the push rod 3 enables forces and torques to be transmitted flawlessly between the push rod 3 and the housing 2.

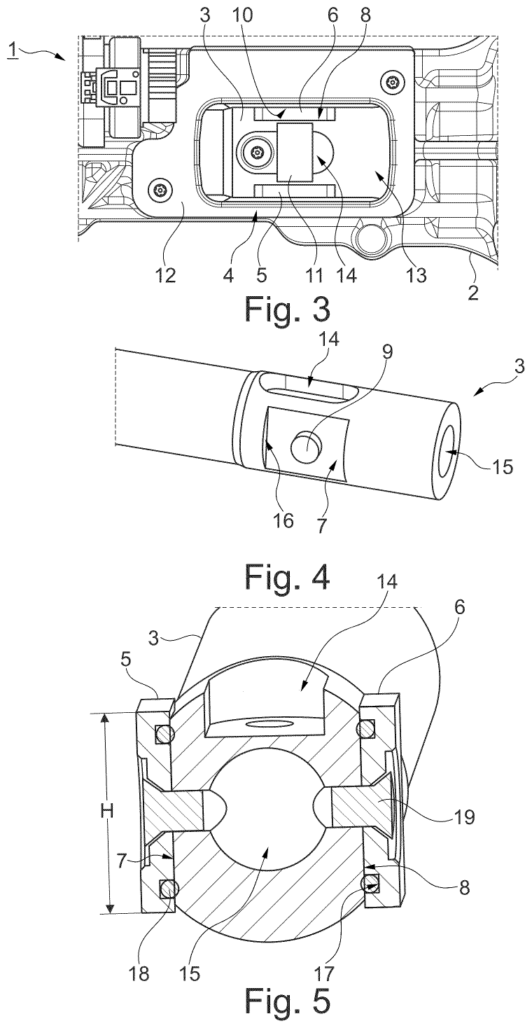

In a circumferential region of the push rod 3 which lies between the abutment faces 7, 8, there is an attachment piece 11 in the exemplary embodiments which is inserted into an elongated depression 14 of the push rod 3. The attachment piece 11 can be provided as an additional supporting element and/or serve measuring purposes. In the view according to FIG. 3, the attachment piece 11 can be seen through an opening 13 in a housing cover 12.

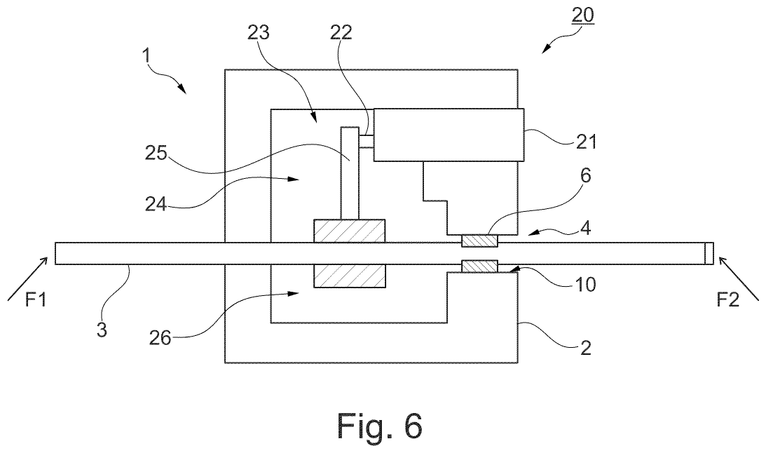

In exemplary embodiments, the push rod 3 is a tube having a cavity which is denoted by 15 and, like the push rod 3, has a circular cross section, at least over most of its length. Alternatively, a solid rod could be used as the push rod 3. The basic installation situation of the push rod 3 is outlined in FIG. 6. The steering actuator 1 which is assigned to the rear-axle steering system 20 can be designed either according to FIGS. 1 to 4 or according to FIG. 5.

The rear-axle steering system 20 comprises an electric motor 21, the motor shaft of which is denoted by 22 and is arranged parallel to the push rod 3. Furthermore, the rear-axle steering system 20 has a transmission assembly 23 with two transmissions 24, 26 connected in series. This is a rotation-rotation transmission 24 in the form of a belt drive, the belt of which is denoted by 25, and a rotation-translation transmission 26 in the form of a roller screw drive.

The two ends of the push rod 3 are connected to tie rods (not shown), which transmit forces F1, F2 to the push rod 3. As indicated in FIG. 6, the forces F1, F2 are oblique in relation to the longitudinal axis of the push rod 3, so bending loads arise within the push rod 3. The anti-rotation mechanism 4 contributes to the absorption of such bending loads, in addition to its primary function, i.e. the anti-rotation function.

### LIST OF REFERENCE SYMBOLS

1 Steering actuator
2 Housing
3 Push rod
4 Anti-rotation mechanism
5 Sliding element
6 Sliding element
7 Abutment face
8 Abutment face
9 Pin
10 Inner wall
11 Attachment piece
12 Housing cover
13 Opening in the housing cover
14 Depression
15 Cavity
16 Abutment edge
17 Groove
18 Resilient element, O-ring
19 Screw
20 Rear-axle steering system
21 Electric motor
22 Motor shaft
23 Transmission assembly
24 Rotation-rotation transmission, belt drive
25 Belt
26 Rotation-translation transmission
B Width of a sliding element
D Diameter of push rod
F1 Force
F2 Force
H Height of a sliding element
W Distance between the abutment faces

1. A steering actuator, comprising:
a housing and,
a push rod guided in the housing, and having
an anti-rotation mechanism which is effective between the housing and the push rod, the anti-rotation mechanism comprising two sliding elements arranged on opposite circumferential sides of the push rod, each of the two sliding elements contacting an inner wall of the housing, and
the two sliding elements are arranged on flattened abutment faces of the push rod and are immovably connected to the push rod in a circumferential direction and in an axial direction, wherein a distance between the abutment faces is smaller than the diameter of the push rod.

2. The steering actuator according to claim 1, wherein the inner wall of the housing is arranged axially parallel to the flattened abutment faces.

3. The steering actuator according to claim 2, wherein each of the two sliding elements is mounted on a pin protruding from each of a corresponding one of the flattened abutment faces.

4. The steering actuator according to claim 3, wherein the two sliding elements each have a rectangular shape, and an extension of each of the two sliding elements in a longitudinal direction of the push rod is greater than an extension of each of the two sliding elements in a tangential direction of the push rod.

5. The steering actuator according to claim 3, wherein the two sliding elements are screwed on the push rod.

6. The steering actuator according to claim 1, wherein the two sliding elements are mounted resiliently on the push rod.

7. The steering actuator according to claim 6, wherein the two sliding elements are mounted resiliently on the push rod via an O-ring inserted between each of the two sliding elements.

8. The steering actuator according to claim 7, wherein the two sliding elements constructed from a material selected from a group of materials consisting of polymer sliding materials and sliding composite materials.

9. The steering actuator according to claim 7, wherein the inner wall of the housing which contacts the sliding elements constructed from a light metal material.

10. The steering actuator according to claim 7, wherein the steering actuator is configured as an actuator of a rear-axle steering system.

11. The steering actuator according to claim 3, wherein the pin is an integral part of the push rod.

12. The steering actuator according to claim 7, wherein the O-ring is configured to provide radial movement of the two sliding elements relative to the push rod.

13. A steering actuator, comprising:
a housing,
a push rod configured to be linearly displaced within the housing via an electric motor and a screw drive, the push rod having:
a first sliding element immovably connected to the push rod in a circumferential direction and an axial direction of the push rod, and
a second sliding element immovably connected to the push rod in the circumferential direction and the axial direction of the push rod, and
the first sliding element and the second sliding element slidably engaging an inner wall of the housing so as to prevent rotation of the push rod,
and each of the first sliding element and the second sliding element are resiliently mounted to the push rod.

14. The steering actuator of claim 13, wherein the first sliding element and the second sliding element are resiliently mounted to the push rod so that the first sliding element and the second sliding element have mobility in a radial direction of the push rod.

15. The steering actuator of claim 14, further comprising:
a first O-ring arranged between the first sliding element and the push rod, and
a second O-ring arranged between the second sliding element and the push rod, and
the first O-ring and the second O-ring configured to provide the mobility of the first sliding element and the second sliding element in the radial direction of the push rod.

16. The steering actuator of claim 14, wherein:
the first sliding element is mounted on a first radially outwardly protruding pin of the push rod, and
the second sliding element is mounted on a second radially outwardly protruding pin of the push rod.

17. A steering actuator, comprising:
a housing,
a push rod configured to be linearly displaced within the housing via an electric motor and a screw drive, the push rod having:
a first sliding element immovably connected to the push rod in a circumferential direction and an axial direction of the push rod, and
a second sliding element immovably connected to the push rod in the circumferential direction and the axial direction of the push rod, and
the first sliding element and the second sliding element slidably engaging an inner wall of the housing so as to prevent rotation of the push rod,
and each of the first sliding element and the second sliding element are mounted on the push rod so as to be radially movable relative to the push rod.

18. The steering actuator of claim 17, wherein the first sliding element and the second sliding element are mounted to a respective first flat surface and a second flat surface of the push rod.

19. The steering actuator of claim 18, wherein the first flat surface and the second flat surface of the push rod are parallel with the inner wall of the housing.

20. The steering actuator of claim 18, further comprising:
a first pin extending radially outwardly from the first flat surface, the first sliding element mounted on the first pin, and
a second pin extending radially outwardly from the second flat surface, the second sliding element mounted on the second pin.
